(19) United States
(12) Patent Application Publication
(10) Pub. No.: US 2026/0309862 A1
(43) Pub. Date: Oct. 8, 2026

(54) SYSTEM FOR PROCESSING SIGNAL FROM RADAR SENSOR FOR TRACKING OBJECT BY USING ARTIFICIAL INTELLIGENCE AND METHOD IMPLEMENTING THE SAME

(71) Applicants: Hyundai Motor Company, Seoul (KR); Kia Corporation, Seoul (KR)

(72) Inventors: Won Je JANG, Gyeonggido (KR); Hyung Chan CHO, Gyeonggido (KR); En Sun LEE, Gyeonggido (KR); So Yeon JEON, Gyeonggido (KR)

(21) Appl. No.: 19/377,970

(22) Filed: Nov. 3, 2025

(30) Foreign Application Priority Data
Apr. 2, 2025 (KR) 10-2025-0042963

(51) Int. Cl. G01S 13/72; G01S 7/28; G01S 7/41; G01S 13/58

(52) U.S. Cl. CPC G01S 13/726; G01S 7/2813; G01S 7/415; G01S 13/58

(57) ABSTRACT

A system and method for recognizing an object using at least one autonomous driving sensor. Specifically, the system can recognize an object in a surrounding environment based on multiple point data input obtained from the at least one autonomous driving sensor. The system performs preprocessing of detection points in the multiple point data, clustering of the preprocessed data into a plurality of clusters, generating cluster information from each of the plurality of clusters, performing association between (i) a current time point cluster information among the cluster information and (ii) a current prediction of a track that has been updated up to a previous time point to generate an association result, and tracking multiple objects based on the association result.

### CROSS-REFERENCE TO RELATED APPLICATION

Pursuant to 35 U.S.C. § 119(a), this application claims the benefit of an earlier filing date and right of priority to Korean Patent Application No. 10-2025-0042963, filed with the Korean Intellectual Property Office on Apr. 2, 2025, the entire contents of which are hereby incorporated by reference.

### TECHNICAL FIELD

The present disclosure relates to a signal processing system and method for tracking an object using artificial intelligence (AI) and an autonomous driving sensor.

### BACKGROUND

With the recent development and commercialization of autonomous vehicles, the use of various sensors and artificial intelligence (AI) technologies to support autonomous driving functions of vehicles is increasing. For example, research is ongoing into techniques for determining what object exists in front of a moving vehicle, what the distance is between the object and the vehicle, and what algorithm the vehicle should use to respond to specific situations to ensure safety.

Accordingly, vehicle sensor technology is becoming more advanced, and high-performance sensors such as light detection and ranging (LiDAR) that recognizes a surrounding environment using a laser beam, radio detection and ranging (RADAR) that uses radio waves, ultrasonic sensors, fisheye cameras capable of shooting 360-degree images, multifocal lenses, and a global positioning system (GPS) are increasingly implemented in vehicles.

Furthermore, by aggregating measurement results obtained from a plurality of sensors, it is possible to implement a so-called super sensor vehicle. In self-driving (autonomous driving), the concept of a super sensor refers to a technology that seeks to more accurately recognize the surrounding environment by combining measurements from various sensors for convenience and safety of driving, rather than relying on individual sensors. With the addition of information and communications technology (ICT) and cloud technology, sensors and AI algorithms for autonomous driving are becoming more sophisticated than ever before, not only for a single vehicle, but also for a fleet of vehicles, remotely accumulating data and training AI servers and databases to increase reliability of vehicle sensor determination.

However, autonomous driving technology using radar still has some problems, such as low recognition rates for objects at a distance.

### SUMMARY

A first aspect of the present disclosure relates to a radar signal processing (RSP) object tracking system for recognizing an object using at least one autonomous driving sensor, including at least one processor and at least one memory storing computer program instructions that, based on being executed by the at least one processor, perform operations of recognizing an object in a surrounding environment based on multiple point data input from the at least one autonomous driving sensor, the operations including performing preprocessing of detection points among the multiple point data, clustering the preprocessed data to generate a plurality of clusters, generating cluster information from each of the plurality of clusters, performing association between (i) a current time point cluster information among the cluster information and (ii) a current prediction of a track that has been updated up to a previous time point to generate an association result, and tracking multiple objects based on the association result.

In a case of an RSP system according to a second aspect of the present disclosure, the at least one autonomous driving sensor may include a plurality of radar sensors.

In a case of an RSP system according to a third aspect of the present disclosure, the preprocessing operation may include a process of converting a sensor coordinate system of each of the radar sensors into a coordinate system of a vehicle equipped with radars.

In a case of an RSP system according to a fourth aspect of the present disclosure, the preprocessing operation may include a process of performing noise filtering using signal information provided by the radar sensors and data information around the detection points.

In a case of an RSP system according to a fifth aspect of the present disclosure, the clustering may include a process of clustering the detection points based on position information and velocity information provided by the radar sensor.

In a case of an RSP system according to a sixth aspect of the present disclosure, the clustering may include a process of performing clustering based on a result of time-series accumulation of data from the radar sensor in a case where there is a detection point existing at a distance that is greater than a certain threshold from the radar sensor.

In a case of an RSP system according to a seventh aspect of the present disclosure, the cluster information may include at least one of a longitudinal velocity, a lateral velocity, a heading direction, a position, or cluster box information.

In a case of an RSP system according to an eighth aspect of the present disclosure, the generating of the clustering information may include a process of generating a representative velocity vector based on Doppler information of the detection point included in the cluster, and generating box information and a representative position of the cluster based on position information of the detection point included in the cluster.

In a case of an RSP system according to a ninth aspect of the present disclosure, the associating may include a process of obtaining the track that has been updated up to the previous time point and a cluster newly observed at the current time point, predicting a current time point position of the track using position and velocity information at the previous time point to generate the current prediction of the track that has been updated up to the previous time point, and performing an association between (i) the current prediction of the track that has been updated up to the previous time point and (ii) multiple clusters among the plurality of clusters.

In a case of an RSP system according to a tenth aspect of the present disclosure, the tracking of the multiple objects may include a process of adjusting an update rate of past data and current observation data.

That is, an eleventh aspect of the present disclosure relates to a radar signal processing (RSP) object tracking method for recognizing an object using at least one autonomous driving sensor, the method including preprocessing detection points among the multiple point data; clustering the preprocessed data to generate a plurality of clusters, generating cluster information from each of the plurality of clusters, performing association between (i) a current time point cluster information among the cluster information and (ii) a current prediction of a track that has been updated up to a previous time point to generate an association result, and tracking multiple objects based on the association result.

### BRIEF DESCRIPTION OF THE DRAWINGS

FIG. 1 illustrates a block diagram showing an example overall system for automatically recognizing objects and controlling a vehicle for purposes such as autonomous driving.

FIG. 2 illustrates a flowchart showing an example overall configuration of a signal processing process based on a radar input.

FIG. 3 illustrates an experimental result showing an example result of noise being filtered according to a preprocessing operation in a signal processing process based on a radar input.

FIG. 4 illustrates an experimental result showing example point clusters (i.e., groups) by color according to a clustering process in a signal processing process based on a radar input.

FIG. 5 illustrates an experimental result of generating an example clustering result as clustering information according to a clustering information generation process in a signal processing processes based on a radar input.

FIG. 6 illustrates an experimental result showing an example result of an association between a track at a previous time point and a cluster at a current time point according to an association process between clusters and tracks in a signal processing process based on a radar input.

FIG. 7 illustrates an experimental result showing example object tracking based on updating track information using new cluster data associated with past tracks in a signal processing process based on a radar input.

FIG. 8 illustrates an experimental result related to example RSP multi-object tracking, verifying that a stable tracking result is determined from radar detection data in a signal processing process based on a radar input.

FIG. 9 illustrates a block diagram showing an example computing system for autonomous vehicle control and object recognition computation.

### DETAILED DESCRIPTION

Implementations of the present disclosure can provide a signal processing system and method for tracking an object using an artificial intelligence (AI) and an autonomous driving sensor, such as a radar sensor. In some implementations, a radar signal processing (RSP) system and a related method are provided that can track multiple objects by processing data in a form of detection points provided by one or more radar sensors.

Implementations of the present disclosure provide a system architecture for signal processing of radar data that can produce a result of tracking objects through a series of processing operations applied to detection points received from multiple radars.

By comparison, other techniques may obtain a tracking result using a method of group tracking the radar data itself or, instead of using the entire radar data, separates only the relevant data through a clustering process and then performs filtering to produce a final tracking result.

However, techniques where a tracking result is obtained by using the group tracking method using all radar data may be difficult to utilize in an actual autonomous driving environment due to excessive computational time. Furthermore, techniques of clustering radar data can have a problems of degraded performance in scenarios where there is a small amount of radar data (e.g., for objects that are observed at long distances).

Accordingly, implementations of the present disclosure can provide a radar processing structure capable of achieving fast and stable performance even in situations where a number of radar data is small, and specifically, a technique of processing data from a radar observation system formed of multiple radar sensors, e.g., five radar sensors, and creating a tracking result.

Implementations of the present disclosure can provide a logic structure that stably and quickly generates a tracking result from radar detection point data. In some implementations, different operations can be utilized, including preprocessing, clustering, cluster information generation, association, and tracking. Radar detection points can be obtained as inputs, and time series data can be accumulated in each of the clustering process and the tracking process. Furthermore, in some implementations, computational efficiency can be improved and logic can be simplified by reducing the use of feedback structures within a single time point, and a logic structure can be implemented such that one processing process is used within a single time point.

Technical benefits can include improvement in performance while reducing waste of a computational time. Furthermore, in some scenarios, various processes executing implementations of the present disclosure can be modularized and have low dependence on each other, so there may be an advantage in that each module may be easily modified (as needed) as long as input and output exist.

In some implementations, the radar signal processing (RSP) structure can process data in a form of detection points provided by one or more radar sensors, and implement a system and method for object recognition and tracking by radar-based signal processing capable of performing clustering and tracking by accumulating time series data twice on a single flow without a feedback loop structure.

Furthermore, various effects in addition to effects described above from the present disclosure by those skilled in the art are provided through the detailed description of the present disclosure and the attached drawings.

Hereinafter, some exemplary implementations of the present disclosure will be described in detail with reference to exemplary drawings. It should be noted that in adding reference numerals to constituent elements of each drawing, the same constituent elements include the same reference numerals as possible even though they are indicated on different drawings. Furthermore, in describing exemplary implementations of the present disclosure, in a case where it is determined that detailed descriptions of related well-known configurations or functions interfere with understanding of the exemplary implementations of the present disclosure, the detailed descriptions thereof will be omitted.

In describing constituent elements according to various implementations of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an exemplary implementation of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification. For example, in the present disclosure, the term ‘object’ is also referred to as ‘entity,’ and the expressions ‘object’ and ‘entity’ will be interchangeably used throughout the present disclosure.

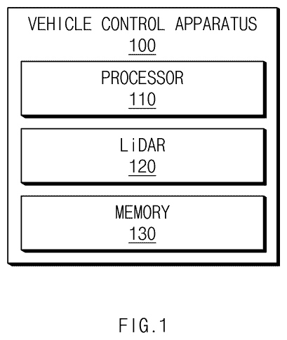

FIG. 1 illustrates a block diagram showing an example overall system for automatically recognizing objects and controlling a vehicle for purposes such as autonomous driving.

Referring to FIG. 1, a vehicle control apparatus 100 according to an implementation of the present disclosure may be implemented inside or outside a vehicle, and some of the components included in the vehicle control apparatus 100 may be implemented inside or outside the vehicle. For example, the vehicle control apparatus 100 may be integrally formed with internal control units of the vehicle, or may be implemented as a separate device to be connected to control units of the vehicle by a separate connection technique. For example, the vehicle control apparatus 100 may further include components not shown in FIG. 1.

The vehicle control apparatus 100 according to an implementation may include a processor 110, a sensor 120 such as LiDAR, and a memory 130. The processor 110, the sensor 120, or the memory 130 may be electronically and/or operably coupled with each other by an electronic component such as a communication bus.

Hereinafter, hardwares being operatively coupled may include a direct connection, and/or an indirect connection established between the hardwares, wired, and/or wireless, such that a second hardware is controlled by a first hardware among the hardwares.

Although different blocks are illustrated in FIG. 1, implementations are not limited thereto. For example, some of the hardwares in FIG. 1 may be included in a single integrated circuit including a system on a chip (SoC). A type and/or number of hardware included in the vehicle control apparatus 100 is not limited to that shown in FIG. 1. For example, the vehicle control apparatus 100 may include some of the hardwares illustrated in FIG. 1.

The vehicle control apparatus 100 according to an implementation may include a hardware for processing data based on one or more instructions. For example, the hardware for processing data may include a processor 110. For example, the hardware for processing data may include an arithmetic and logic unit (ALU), a floating point unit (FPU), a field programmable gate array (FPGA), a central processing unit (CPU), and/or an application processor (AP). The processor 110 may be configured to have a single-core processor structure, or a multi-core processor structure including dual core, quad core, hexa core, or octa core.

According to another implementation, the processor 110 may be configured to include at least one of a graphic processing unit (GPU), a neural processing unit (NPU), or any combination thereof. For example, the GPU may be referred to as a visual processing unit (VPU). For example, the NPU may be referred to as a neural network processing unit.

The vehicle control apparatus 100 according to an implementation may include a sensor 120, such as a depth sensor, for detecting external objects. For example, the depth sensor for detecting external objects may include at least one of a time of flight (ToF) sensor, a light detection and ranging (LiDAR), a structured light sensor, an ultrasonic sensor, an infrared sensor, a radio detection and ranging (RADAR), an optical distance sensor, or any combination thereof. Hereinafter, for ease of exposition, a description will focus on implementing the sensor 120 using the LiDAR, but implementations are not limited thereto.

The vehicle control apparatus 100 according to an implementation may include a lidar sensor 120 that acquires a plurality of points based on a pulse laser signal. For example, the lidar sensor 120 can acquire data sets that identify objects surrounding the vehicle control apparatus 100 (or a vehicle including the vehicle control apparatus 100). For example, the lidar sensor 120 can identify at least one of a position, a moving direction, a velocity, or any combination thereof of a surrounding object based on the pulse laser signal emitted from the lidar sensor 120 being reflected back by the surrounding object.

For example, the lidar sensor 120 may obtain data sets representing external objects in a space formed by an x-axis, a y-axis, and a z-axis based on the pulse laser signal reflected from the surrounding object. For example, the lidar sensor 120 may acquire data sets including a plurality of points in the space formed by the x-axis, the y-axis, and the z-axis based on receiving the pulse laser signal every a designated period. For example, the points may include points representing external objects within a 3D virtual coordinate system. The 3D virtual coordinate system may include at least one of a vehicle coordinate system, a lidar coordinate system, or any combination thereof. However, an example of the 3D virtual coordinate system is not limited to those described above.

The memory 130 of the vehicle control apparatus 100 according to an implementation may include a hardware component for storing data and/or instructions input to and/or output from the processor 110 of the vehicle control apparatus 100. For example, the memory 130 may include a volatile memory including a random-access memory (RAM), and/or a nonvolatile memory including a read-only memory (ROM).

For example, the volatile memory may include at least one of a dynamic RAM (DRAM), a static RAM (SRAM), a Cache RAM, a pseudo SRAM (PSRAM), or any combination thereof. For example, the nonvolatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof.

Within the memory 130 of the vehicle control apparatus 100, one or more instructions (or commands) indicating computations and/or actions to be performed by the processor 110 of the vehicle control apparatus 100 based on data may be stored. A set of one or more instructions may be referred to as a program, a firmware, an operating system, a process, a routine, a sub-routine, and/or an application.

Hereinafter, a point that an application is installed in a vehicle control apparatus 100 may indicate that one or more instructions provided in a form of an application are stored in the memory 130, and that one or more applications are stored in a format that is executable by the processor 110 of the vehicle control apparatus 100 (e.g., a file having an extension designated by an operating system of the vehicle control apparatus 100).

For example, the memory 130 may include a first neural network model for detecting an object. For example, the memory 130 may include a second neural network model for outputting types of the points acquired by the lidar sensor 120 and/or scores of the points.

In an implementation, the processor 110 may be configured to obtain at least one of a first virtual box representing a target object, a first class representing a type of the target object, or any combination thereof, based on the points acquired through the lidar sensor 120 and the first neural network model stored in the memory 130.

For example, the processor 110 may be configured to obtain at least one of a first virtual box representing a target object, a first class representing a type of the target object, or any combination thereof, based on inputting a plurality of points into the first neural network model. For example, the first neural network model may include an object detection model. For example, the target object may include an external object positioned within a designated distance from the vehicle control apparatus 100 (or a vehicle including the vehicle control apparatus 100). For example, the target object may include an object that is identified by the vehicle control apparatus 100 and is tracked, e.g., continuously tracked. For example, the type of the target object may be one or more of multiple types for classifying the target object. For example, the type of the target object may include at least one of a first type representing a ground, a second type representing a type that is different from the ground, or any combination thereof. However, the type of the target object is not limited to what was described above. For example, the type of the target object may include at least one of a third type representing a person, a fourth type representing a vehicle, or any combination thereof, but the present disclosure is not limited thereto.

In an implementation, the processor 110 may be configured to obtain, based on the points and the second neural network model, at least one of first partial points corresponding to at least a portion of the target object among the points, a second class identified through the first partial points and indicating the type of the target object, or any combination thereof. For example, the second neural network model can include a segmentation model.

For example, the second neural network model may include a neural network model for obtaining types of multiple points and scores of the points.

For example, the processor 110 may be configured to obtain first partial points corresponding to at least a portion of the target object among the points based on inputting the points into the second neural network model. For example, the processor 110 may be configured to identify the types of the points based on inputting the points into the second neural network model. For example, the processor 110 may be configured to obtain first partial points corresponding to at least a portion of the target object from among the points based on the type of each of the points.

In an implementation, the processor 110 may be configured to perform a first designated algorithm on the points. For example, the processor 110 may be configured to perform the first designated algorithm for classifying a type of each of the points for the points. For example, the processor 110 may be configured to classify second partial points corresponding to a designated type among the points. For example, the designated type may include a type representing the ground.

For example, the processor 110 may be configured to classify the second partial points corresponding to a designated type based on performing the first designated algorithm on the points and obtain (or identify) the first partial points by excluding the second partial points from among the points.

For example, the processor 110 may be configured to obtain at least one of a partial class for obtaining a second class, a score for each of the points, or any combination thereof, based on inputting the points into the second neural network model. For example, the processor 110 may be configured to obtain a partial class and a score for each of the points based on inputting the points into the second neural network model. For example, the partial class may contain a classification of each of the points into an arbitrary type.

For example, the processor 110 may be configured to fuse the partial class, the scores of each of the points, and the second partial points. For example, the processor 110 may be configured to perform clustering based on fusing the partial class, the scores of each of the points, and the second partial points. For example, the clustering may involve grouping first partial points that correspond to at least a portion of the target object.

For example, the processor 110 may be configured to obtain a point cloud for generating a second virtual box based on the first partial points. For example, the processor 110 may be configured to obtain the point cloud based on grouping the first partial points.

For example, the processor 110 may be configured to generate a second virtual box, different from the first virtual box and for representing the target object, based on the point cloud. For example, the second virtual box may include a box that includes at least some of the first partial points.

For example, the processor 110 may be configured to identify a heading direction indicating a traveling direction of the target object based on at least one of the first partial points, the point cloud, or any combination thereof.

For example, the processor 110 may be configured to identify a position of a second virtual box in a virtual coordinate system based on at least one of the first partial points, the point cloud, or any combination thereof. For example, the processor 110 may be configured to identify a size of the second virtual box based on at least one of the first partial points, the point cloud, or any combination thereof. For example, the processor 110 may be configured to identify a second class based on at least one of the first partial points, the point cloud, or any combination thereof. For example, the processor 110 may be configured to identify at least one of the heading direction indicating the traveling direction of the target object, a position of the second virtual box in the virtual coordinate system, the size of the second virtual box, the second class, or any combination thereof, based on at least one of the first partial points, the point cloud, or any combination thereof. For example, the processor 110 may be configured to identify the heading direction of the bounding box based on at least one of the first virtual box, the first class, the heading direction of the second virtual box, the position of the second virtual box, the size of the second virtual box, the second class, or any combination thereof. For example, the processor 110 may be configured to identify a position of the bounding box in the virtual coordinate system based on at least one of the first virtual box, the first class, the heading direction of the second virtual box, the position of the second virtual box, the size of the second virtual box, the second class, or any combination thereof. For example, the processor 110 may be configured to obtain a third class indicating a type of the target object corresponding to the bounding box based on at least one of the first virtual box, the first class, the heading direction of the second virtual box, the position of the second virtual box, the size of the second virtual box, the second class, or any combination thereof. For example, the processor 110 may be configured to obtain at least one of the heading direction of the bounding box, the position of the bounding box in the virtual coordinate system, the third class indicating the type of the target object corresponding to the bounding box, or a combination thereof, based on at least one of the first virtual box, the first class, the heading direction of the second virtual box, the position of the second virtual box, the size of the second virtual box, the second class, or a combination thereof.

For example, the processor 110 may be configured to assign, to the second virtual box, a first identifier for tracking the second virtual box. For example, the processor 110 may be configured to assign, to the bounding box, a second identifier corresponding to the first identifier.

For example, the processor 110 may be configured to track the bounding box using the second identifier. For example, the processor 110 may be configured to track the target object based on identifying a plurality of bounding boxes that include a bounding box to which the second identifier is assigned, in a plurality of frames. For example, in scenarios where the second identifier is assigned to a bounding box corresponding to the target object, the processor 110 may be configured to track the target object by identifying the bounding boxes to which the second identifier is assigned in the frames.

In an implementation, the processor 110 may be configured to output a bounding box corresponding to the target object based on at least one of the first virtual box, the first class, the first partial points, the second class, or any combination thereof. For example, the bounding box may include an example of the target object represented in the virtual coordinate system in the form of a hexahedron.

Hereinafter, operations performed by a CPU, a GPU, and/or a NPU included in the processor 110 will be briefly described.

In an implementation, the processor 110 may be configured to include at least one of a CPU, a GPU, an NPU, or any combination thereof. For example, at least one of the GPU, the NPU, or any combination thereof may obtain the first virtual box and the first class based on the first neural network model. For example, at least one of the GPU or the NPU may acquire the first virtual box and the first class. For example, at least one of the GPU, the NPU, or any combination thereof may obtain scores for each of the partial classes and the points for obtaining the second class based on the second neural network model. For example, at least one of the GPU or the NPU may obtain scores for each of the partial classes and the points for obtaining the second class based on the second neural network model. For example, the CPU may classify second partial points corresponding to a designated type among the points based on performing the first designated algorithm for classifying types of each of the points for the points.

As described above, the vehicle control apparatus 100 according to an implementation may be configured to include at least one processor 110. The vehicle control apparatus 100 may be configured to accurately detect a target object by detecting the target object using at least one processor 110. Additionally, by performing parallel processes, the vehicle control apparatus 100 may be configured to reduce a load on each processor.

Object recognition is described next, including examples based on specific scenarios. Specifically, a description is provided of examples of AI object recognition, specifically regarding LiDAR-based object recognition.

In some implementations, an object recognition process involving the LiDAR sensor 120 and an AI module may go through three operations: preprocessing, segmentation, and tracking.

Pre-processing can be performed by the object recognition system 1000, before executing the object recognition function. The preprocessing may include, e.g., removing points forming the ground based on laser sensing data (i.e., unprocessed raw data) input from the LiDAR sensor 120. Because a laser beam reflected from the ground could be mistakenly recognized as if there is an object on the ground, a process of distinguishing between the ground and non-ground objects may be performed in a preprocessing operation, and in some scenarios, may also be performed in a segmentation operation.

For example, the preprocessing in AI object recognition can implement an image processing tool of the AI module in a processor 110 to remove noise from a LiDAR point cloud image and reduce a total number of points existing in the LiDAR point cloud image through, e.g., a voxel downsampling technique to improve a computational efficiency.

For reference, a LiDAR point cloud image may also be displayed in a bird's eye view (BEV) mode. In a case where a LiDAR map is created to resemble a bird's eye view of a city while flying in the sky, they are called a BEV image.

In some implementations, as described above, the LiDAR sensor 120 may emit a laser beam into a surrounding environment, record a round-trip time it takes for the laser beam to be reflected by an external object and return, generate a point for each of numerous laser signals, and determine a distance to that point. By repeatedly emitting numerous laser beams, the processor 110 may be configured to generate a real-time LiDAR map of the surrounding environment as a three-dimensional map of the BEV type, and as a two-dimensional map in some scenarios.

In the LiDAR point cloud map, the lines or surfaces appearing in black and white can be formed of a large number of points, each of which is generated based on the laser beams of the LiDAR sensor 120, and for this reason, a LiDAR sensing image is also referred to as a LiDAR point cloud image. In some implementations, by combining an RGB-D (Red, Green, Blue-Depth) sensor with a LiDAR sensor, a LiDAR point cloud image may be reconstructed in color.

Although it can be challenging for a human to recognize objects using individual points within a LiDAR point cloud image, by synthesizing the point cloud from perspectives such as a BEV or 2D plan view, it may become possible to roughly estimate the appearance of the surrounding environment of the vehicle currently in an autonomous driving mode. Furthermore, it may be possible to recognize a vehicle, a bus, a pedestrian, a street tree, a traffic sign, etc. within the LiDAR point cloud image. In AI image recognition, these human and things are referred to as objects, and each object may be classified into a specific group, known as a class, such as a vehicle class, a bus class, and so on.

Distinguishing which object in the LiDAR point cloud image belongs to the vehicle class or the bus class can involve utilization of machine learning, such as a deep AI neural network. In some cases, to detect objects within the LiDAR point cloud image through the AI neural network and identify their classes, the AI neural network can be trained beforehand, for exampling using one or more training datasets.

For example, the dataset called PANDASET™ (source: https://pandaset.org/#data-collection) may include over 48,000 camera images (mostly taken in the Silicon Valley area of the United States) and more than 16,000 LiDAR scan images, which are annotated with a total of 28 classes, including pedestrians, passenger vehicles, bicycles, construction site signs, and traffic signs.

Furthermore, an LiDAR point cloud image may be visualized according to a user-selected option using a point cloud processing tool such as Open3D™ (source: https://www.open3d.org/). The LiDAR sensor 120 may be capable of distance detection, so a 3D LiDAR image may be rendered more realistically during visual processing with a tool like Open3D™, and for instance, an object at a greater distance may be displayed in dark blue, while a closer object may be shown in light blue.

Furthermore, as mentioned above, in some implementations an original LiDAR image (i.e., raw data) may be preprocessed by applying a technique such as voxel (3D pixel) to apply downsampling to the LiDAR point cloud image. Herein, a voxel (volumetric pixel) refers to a cube-shaped 3D pixel, and the voxel down-sampling can reduce a number of points in the LiDAR point cloud while maintaining structures of various objects included therein, thereby reducing an excessive AI computation requirement.

In some implementations, the LiDAR sensor 120 may emit “m” laser beams “n” times during a single scan cycle, and scan values of the laser beams that reflect and return from external objects can be collectively represented as an (m×n) matrix, which is referred to as a range image. Each point in the LiDAR point cloud image may include depth (e.g., range) information, as well as additional details such as intensity, azimuth, inclination, and other additional information of returned laser pulse. Range images may be used for AI training with large datasets, such as Waymo™ Open Dataset (WOD).

Range view (RV) refers to a technique that converts 3D point clouds into 2D or 2.5D scenes, allowing LiDAR 3D maps to be represented in a way that is more intuitively understandable to humans, resembling an analog drawing rather than a collection of countless points. In a range view image, a 3D LiDAR point cloud image may have 2D coordinates, but a 3D laser-related information (angle, inclination, intensity, etc.) recorded in response to obtaining the range image may not be discarded. A 3D LiDAR image's (x, y, z) coordinates may be transformed into a 2D range view image by applying a width variable to the (x, y) coordinates to obtain the coordinates of one axis in two dimensions and applying a height variable and range image information indicating a range (depth) to the (z) coordinate to obtain the coordinates of another axis in two dimensions.

Furthermore, the AI algorithm according to implementations of the present disclosure can include a convolutional neural network (CNN), which can be trained by an AI training module to extract features (or feature points) from image data. For example, the training can utilize datasets including tens of thousands of images, and the CNNs can process images from one-dimensional to three-dimensional. As such, a result of a range view image processing tool can be used to train a CNN to perform a function of helping AI accurately recognize objects in an image.

In scenarios where objects around autonomous vehicles are recognized through machine-learning, the object recognition process can include generating a ground truth (GT) bounding box on the aforementioned LiDAR map. In machine learning, GT (ground truth) is a term used to indicate an original or actual value of data that AI is trying to learn. In some implementations, the GT can, be visually represented by an annotation, such as a bounding box with a box-shaped boundary applied to a LiDAR point cloud image.

In some implementations, the AI module may retrieve labels to recognize objects and group various objects. For example, an interval or spacing of 3D data points that are used to output a GT bounding box may also be set, which can determine the number of points in the bounding box. For example, one GT bounding box may be set to include 50 to 1000 LiDAR cloud points.

In some scenarios, the GT annotation may not exist in raw data captured by sensors such as the LiDAR sensor 120 while the vehicle is driving. In such scenarios, the processor 110 can perform the task of recognizing objects belonging to various classes, such as a road sign, a crosswalk, a pedestrian, another vehicle, a center lane, etc., as objects, and GT annotation may be utilized to measure object recognition errors by comparing object determination results recognized by the AI algorithm of the processor 110 with actual outcomes, and sometimes evaluate AI performance. The GT bounding box, which is applied to an original image in the form of annotation, may be set manually by a user, or can be set through a GT calculation tool, such as grid-striding.

AI object recognition can also utilize predicted bounding boxes. A predicted bounding box can represent a result that is recognized by the processor 110 as an object of a specific class from original image data obtained from sensors such as the LiDAR sensor 120. The predicted bounding box may appear similar to the GT bounding box. However, unlike the GT bounding box, the predicted bounding boxes are computational results of autonomous driving AI. The predicted bounding box may match the GT bounding box, but it may not match the GT bounding box or may not overlap it at all.

In some scenarios, the predicted bounding boxes alone may not definitively determine that an object of a specific class actually exists at a specific position, and so the predicted bounding boxes can also be referred to as probability boxes (P-Boxes).

Segmentation processing can be performed after preprocessing. Segmentation processing can, for example, involve displaying a specific part of a road (e.g., a traffic light) with a particular annotation (e.g., in color red) and other parts (e.g., asphalt road) with another annotation (e.g., in color blue). Segmentation can also involve clustering point clouds into groups and generating P-Boxes. In some scenarios, cluster expansion can be used, where an expansion target may include a cluster that is expanded to include all points within a given distance from a seed point plus an additional incremental epsilon distance (where the given distance from the seed point constitutes the unexpanded cluster).

In some implementations, during segmentation processing, clustering and P-Box generation may be performed based on a point cloud. As such, an AI network performing segmentation can be used to obtain a point label from the LiDAR sensor 120.

Implementations of the present disclosure can utilize a “rule-based” road surface recognition and label fusion technique. This can help mitigate a problem of ground recognition errors occurring during segmentation. Such road surface recognition algorithms can apply any of a variety of techniques, including slope-based road surface recognition, grid-based road surface recognition, and other non-planar-based road surface recognition. Implementations of the present disclosure are described based on a slope-based road surface recognition technique in a case of recognizing a road surface inside a tunnel.

For reference, semantic segmentation can involve assigning a unique class label to each point in a point cloud generated by the LiDAR sensor 120. Semantic segmentation in LiDAR image processing can be used to determine and utilize meaningful information from LiDAR data for object recognition or scene reconstruction, for implementing autonomous driving. Various semantic segmentation AI models can be used, such as a projection-based method, a point-based method, and a sparse convolution-based method. For example, a result of semantic segmentation can be generated by AI computations performed by the processor 110 using a NVIDIA DRIVE™ AGX system, and through such a configuration, various colors may be added to a LiDAR point cloud image.

After performing a segmentation process as described above, in some implementations, the LiDAR image may undergo postprocessing. Postprocessing can involve converting point cloud data into 3D maps or modeling, which can be meaningful information for autonomous driving. Postprocessing can also include, in some scenarios, removing noise and errors from the LiDAR point cloud image, recognizing objects such as vehicles and pedestrians from the point cloud, and, in some cases, registering point cloud information by attaching a unique identifier thereto.

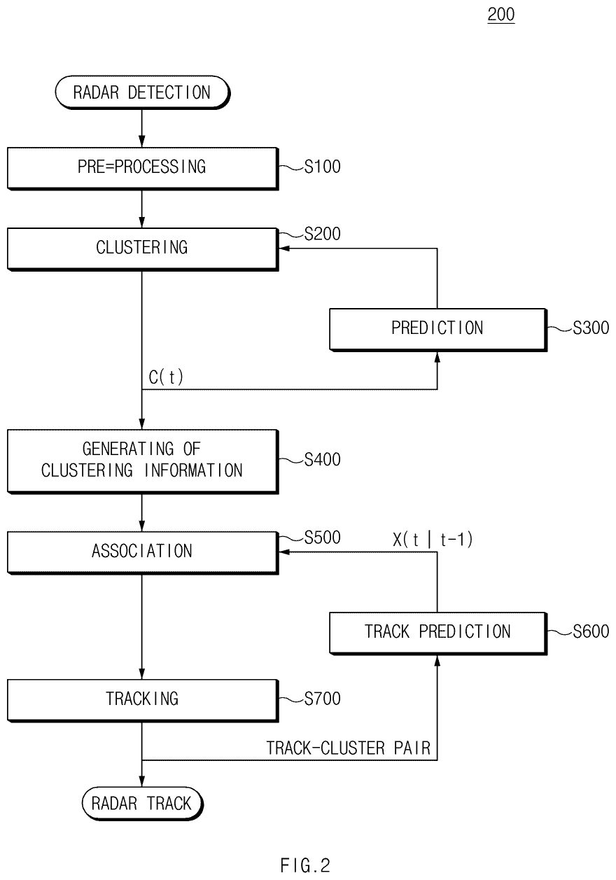

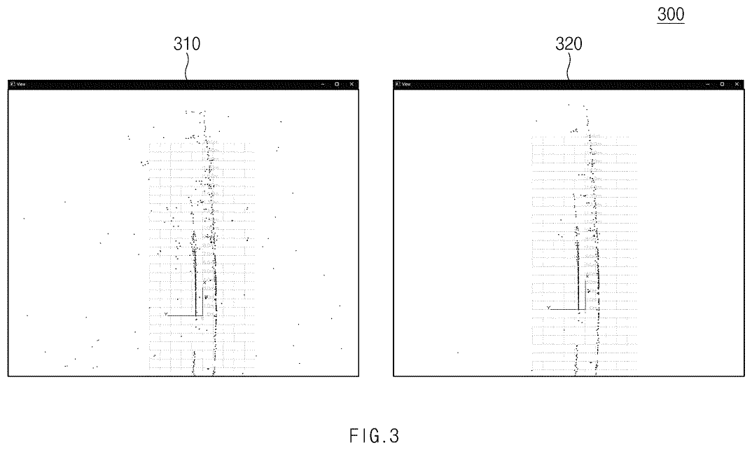

FIG. 2 illustrates a flowchart showing an example overall configuration of a signal processing process (200) based on a radar input. For better understanding and ease of description, the different operations shown in FIG. 2 will be described in conjunction with references to FIG. 3 to FIG. 6 as appropriate to describe each operation illustrated in FIG. 2.

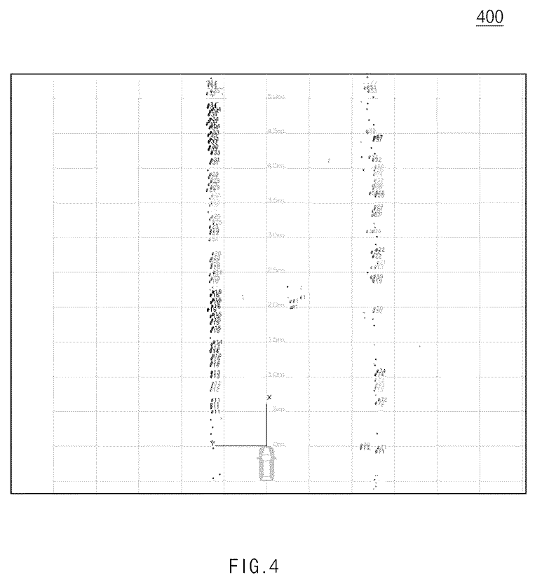

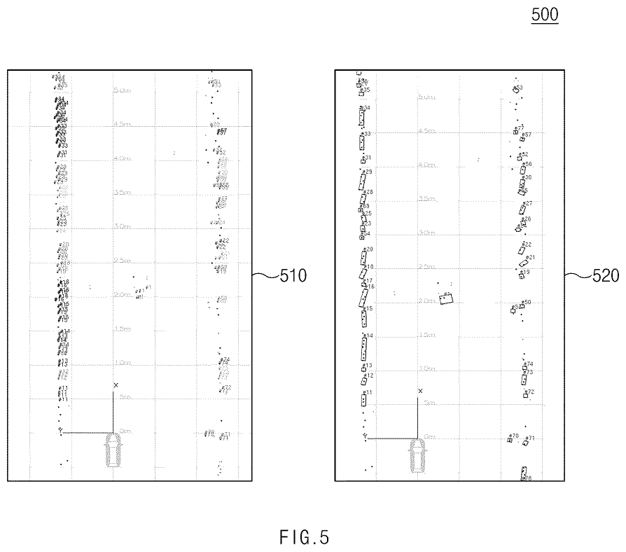

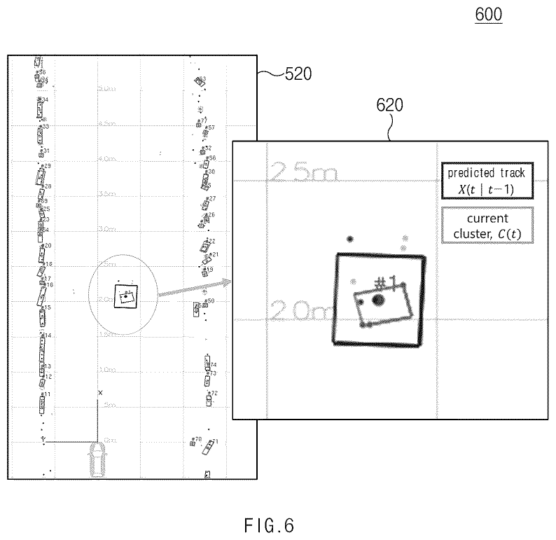

In particular, FIG. 3 illustrates an experimental result showing an example result of noise being filtered according to a preprocessing operation in a signal processing process based on a radar input. FIG. 4 illustrates an experimental result showing example point clusters (i.e., groups) by color according to a clustering process in a signal processing process based on a radar input. FIG. 5 illustrates an experimental result of generating an example clustering result as clustering information according to a clustering information generation process in a signal processing processes based on a radar input. FIG. 6 illustrates an experimental result showing an example result of an association between tracks and clusters, according to an association process between clusters and tracks in a signal processing process based on a radar input. In particular, the association is between (i) a prediction of a track at a current time point based on information updated to a previous time point and (ii) a cluster at the current time point.

Referring again to FIG. 2, in Operation S100, data can be detected from at least one radar sensor (e.g., radar sensor 120) is obtained, and preprocessing is performed on the data using at least one processor (e.g., a processor 110 and a computing system 1000 including an AI module).

The preprocessing of Step S100 may be implemented, for example, by the preprocessing features described above. In some implementations, Operation S100 can include processing point data that has been detected and received from multiple radar sensors, e.g., five radars appropriately positioned around the vehicle. In some implementations, the data may undergo transformation from a radar sensor coordinate system (e.g., for each radar sensor) to a coordinate system of the vehicle equipped with the radar sensors, thus creating a single data format. In some scenarios, radar detection points can include noise, which can manifest as spurious points or randomly spread points in the data. Noise filtering can be performed in Operation S100 using signal information provided by the radar sensor 120 and data information surrounding the detection point. The signal information of the radar sensor include distance, velocity, reflected intensity, signal phase information, and whether the signal is modulated/coded. The data information surrounding the detection point include information about other detection points located around it.

An example result of noise filtering is shown in FIG. 3, which illustrates an experimental result (300) showing an example result of noise being filtered according to a preprocessing operation in a signal processing process based on a radar input.

In this example, a point cloud 310 on a left side of FIG. 3 may represent a case where a filtering process has not been performed, and a point cloud 320 on a right side may represent a case where the filtering process has been performed. As shown, a significant number of points that are unnecessary for object analysis have been removed to achieve the point cloud 320 shown on the right.

In Operation S200 of FIG. 2, a clustering process may be performed. For example, clustering of detection points from which noise has been removed can be performed in Operation S100. This can have technical benefits such as reducing an AI determination time required for object tracking using radar,.

By utilizing specific characteristics of the sensor (e.g., radar sensors), point cloud clustering can be performed using both velocity information (e.g., using the radio and Doppler principles) and position information, and points that are not clustered may be filtered out as invalid detection points.

However, in some scenarios the point data can be sparse, and this can result in poor clustering results. For example, in a case of distant objects, the point data can be sparse. The sparsity of point data in such scenarios could result in poor clustering performance, increasing likelihood of being filtered out as invalid points. According to implementations of the present disclosure, a technique of performing “detection point accumulation” and then clustering the accumulated points can be applied to improve performance of recognizing distant objects. Such techniques can have the benefits of mitigating a point sparsity problem of radar points (e.g., for distant objects). The detection point accumulation include an algorithm that improves clustering performance by accumulating detection points acquired during a certain number of past frames adjacent to the current frame and using them in a clustering algorithm, if the key detection points are determined to be extracted from an object based on the relative distance change rate and the RCS (Radar Cross Section) value of each detection.

An example result of detection point accumulation is shown in FIG. 4, which illustrates an experimental result (400) showing example point clusters (e.g., groups) distinguished by different colors according to a clustering process in a signal processing process based on a radar input. Referring to the example experimental result (400), points expressed in a same color form one cluster, and this cluster can become the basis for object recognition. Particularly, as shown in this example, a point sparsity problem of a distant object can be largely resolved by applying a detection point accumulation technique according to the present disclosure.

In Operation S400 of FIG. 2, cluster information may be generated. For example, various types of physical information can be determined for a cluster unit (e.g., for each cluster of different colors as shown in FIG. 4). The physical information can include, for example, a longitudinal speed, a lateral speed, a heading direction, a position, cluster box information, etc. For example, due to specific characteristics of radar sensors, such as radar sensor 120, detection points included in each cluster can have Doppler information, in which case the Doppler information can be analyzed to generate a representative velocity vector in Operation S400. As other examples, a representative position and box information of the cluster can be generated in Operation S400 using position information of detection points included in the cluster.

An example result of clustering is shown in FIG. 5, which illustrates an experimental result (500) of generating an example clustering result as clustering information according to a clustering information generation process in a signal processing processes based on a radar input. In this example, the left screen 510 of FIG. 5 shows a clustered result as in FIG. 4, and the right screen 520 shows an appearance after physical information is determined from each cluster displayed on the left screen 510.

In Operation S300 of FIG. 2, prediction can be performed, in which an object can be predicted, e.g., by an object detection (OD) network in the AI module, based on a result clustered in Operation S200. In some implementations, the P-Box described above can be created in this operation. In such scenarios, the generation of clustering information in Operation S400 can use the P-Box information generated in the prediction of Operation S300.

In Operation S500 of FIG. 2, association may be performed between clusters and tracks. For example, an association operation can be performed between (i) the track predicted at a current time point based on information updated up to the previous time point and (ii) a newly observed cluster at the current time point. For example, to obtain (i), the previous time point track X(t−1) can undergo prediction to predict a position of the current time point of the track X(t|t−1), using the position and velocity information only up to the previous time point t−1 (e.g., through a track preprocessing process). In some scenarios, tracks and clusters can be associated in a many-to-one correspondence rather than a one-to-one correspondence. For example, an object can be divided into multiple clusters based on a state of data, in which case a single track can be associated with the multiple clusters of the tracked object.

An example result of association is shown in FIG. 6, which illustrates an experimental result (600) showing an example result of an association between (i) a track predicted at a current time point based on information collected up to at a previous time point and (ii) a cluster at the current time point, according to an association process between clusters and tracks in a signal processing process based on a radar input. In FIG. 6, an enlarged display 620 of the result screen 520 shows the predicted track at a current time based on information collected up to a previous time, X(t|t−1), as the outer thick-outlined box and the current cluster C(t) as the inner box annotated #1.

In more detail, Operation S600 of FIG. 2 can generate the track prediction X(t|t−1). For example, predicted track information can include a track position, a track box shape, a track velocity, a track heading, an age, reliability, etc. As discussed above, the track prediction X(t|t−1) is a prediction of the track at current time t based on information collected up to previous time t−1. For example, a state transition model can be used to generate the prediction X(t|t−1) from X(t−1) using previously collected cluster information up to time t−1, such as speed, heading, and position information.

Operation S700 of FIG. 2 can generate a tracking result. For example, the track information can be updated using the new cluster information at the current time for C(t) that has been associated with the predicted track X(t|t−1). This process can generate a track that is updated to current time t using information collected up to current time t. For example, the updated track information may include a track position, a track box shape, a track velocity, a track heading, reliability, etc. as mentioned above. According to some implementations of the present disclosure, an update ratio between a past value and current observation data can be adjusted to generate a stable tracking result. The past value include past value of the tracking results. Also the update ratio between a past value and current observation data can be determined based on the reliability each the past value and current observation data.

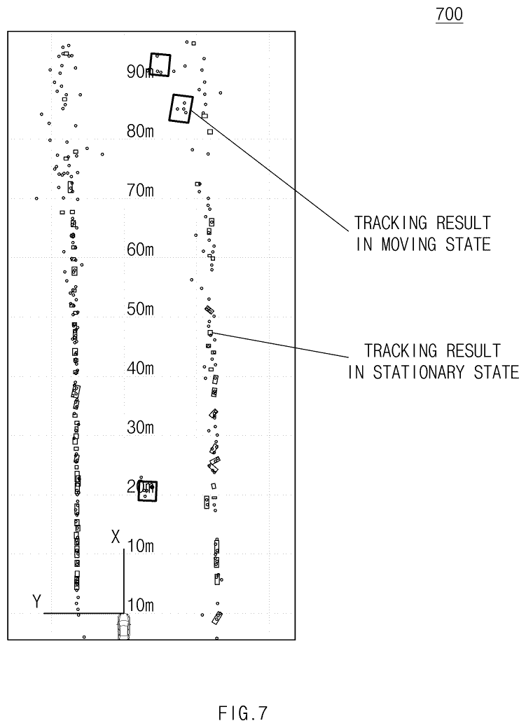

An example result of updating track information is shown in FIG. 7, which illustrates an experimental result (700) showing example object tracking based on updating track information using new cluster data associated with tracks predicted based on past data, in a signal processing process based on a radar input. In the example FIG. 7, a distinction can be made between a tracking target that is stationary and a tracking target that is moving.

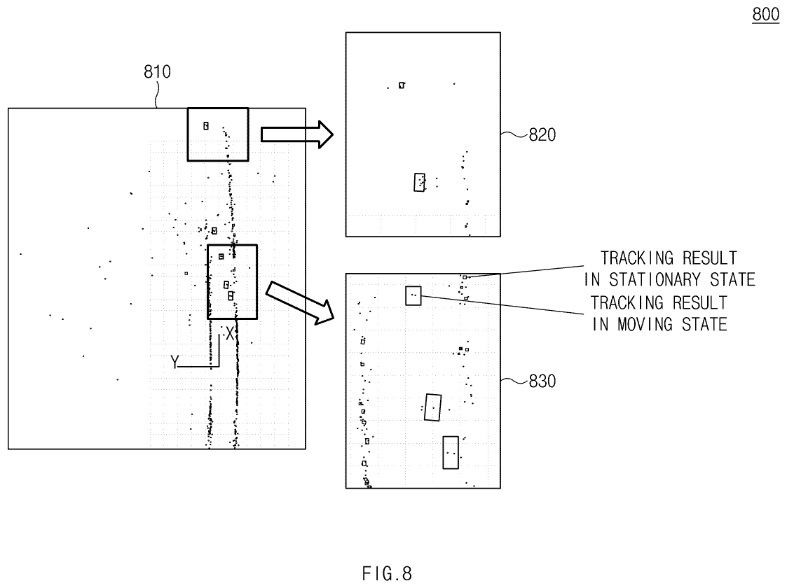

FIG. 8 illustrates an experimental result (800) related to example RSP multi-object tracking, showing that a stable tracking result is determined from radar detection data in a signal processing process based on a radar input. Referring to experimental result screen 810 and two enlarged screens 820 and 830 showing different portions of 810, this example shows that a tracking result of radar signal processing (RSP) multi-object detection remain stable across an entire range.

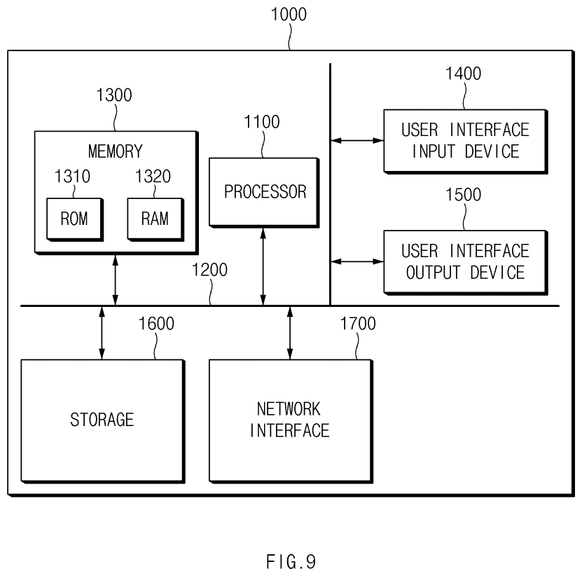

FIG. 9 illustrates a block diagram showing an example computing system 1000 for autonomous vehicle control and object recognition computation.

Referring to FIG. 9, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) and a random access memory (RAM).

Accordingly, steps of a method or algorithm described in connection with the exemplary implementations included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary implementations disclosed in the present disclosure are not intended to limit the technical ideas of the present disclosure, but to explain them, and the scope of the technical ideas of the present disclosure is not limited by these exemplary implementations. The protection range of the present disclosure should be interpreted by the claims below, and all technical ideas within the equivalent range should be interpreted as being included in the scope of the present disclosure.

What is claimed is:

1. A radar signal processing (RSP) object tracking system adapted to recognize an object in conjunction with an autonomous driving sensor, the system comprising:
at least one autonomous driving sensor;
at least one processor; and
at least one memory storing computer program instructions that, based on being executed by the at least one processor, perform artificial intelligence (AI)-based operations of recognizing an object in a surrounding environment based on multiple point data input from the at least one autonomous driving sensor, the operations comprising:
obtaining the multiple point data from the at least one autonomous driving sensor;
performing preprocessing of detection points from the multiple point data to generate preprocessed data;
performing clustering on the preprocessed data to generate a plurality of clusters each comprising one or more points;
generating cluster information from each of the plurality of clusters;
generating a current prediction for a track that has been updated up to a previous time point but has not been updated to the current time point;
performing association between (i) current time point cluster information among the cluster information and (ii) the current prediction of the track that has been updated up to the previous time point, to generate an association result; and
performing tracking of multiple objects based on the association result.

2. The system of claim 1, wherein
the at least one autonomous driving sensor includes a plurality of radar sensors.

3. The system of claim 2, wherein:
the performing of the preprocessing includes converting a sensor coordinate system of each of the plurality of radar sensors into a coordinate system of a vehicle equipped with the plurality of radars.

4. The system of claim 3, wherein
the performing of the preprocessing includes performing noise filtering using signal information provided by the plurality of radar sensors and data information around the detection points.

5. The system of claim 2, wherein
the clustering includes clustering the detection points into the plurality of clusters based on position information and velocity information obtained from the plurality of radar sensors.

6. The system of claim 5, wherein
the clustering includes performing clustering based on a result of time-series accumulation of the multiple point data from the plurality of radar sensors, based on a determination that there is a detection point at a distance greater than a threshold distance from the plurality of radar sensors.

7. The system of claim 2, wherein
the cluster information includes at least one of a longitudinal velocity, a lateral velocity, a heading direction, a position, or cluster box information.

8. The system of claim 7, wherein
the generating of the cluster information includes:
determining Doppler information for a detection point in a cluster among the plurality of clusters;
generating a representative velocity vector based on the Doppler information for the detection point included in the cluster; and
generating box information and a representative position of the cluster based on position information of the detection point included in the cluster.

9. The system of claim 2, wherein
the performing of the association includes:
obtaining the track that has been updated up to the previous time point and a cluster newly observed at the current time point,
predicting a current time point position of the track using position and velocity information at the previous time point to generate the current prediction of the track that has been updated up to the previous time point, and
performing an association between (i) the current prediction of the track that has been updated up to the previous time point and (ii) multiple clusters among the plurality of clusters.

10. The system of claim 1, wherein
the performing of the tracking of the multiple objects includes adjusting an update rate of past data and current observation data.

11. An artificial intelligence (AI)-based radar signal processing (RSP) object tracking method configured to recognize an object in conjunction with at least one autonomous driving sensor, the method:
performing preprocessing on detection points in the multiple point data to generate preprocessed data;
performing clustering on the preprocessed data to generate a plurality of clusters each comprising one or more points;
generating cluster information from each of the plurality of clusters;
generating a current prediction for a track that has been updated up to a previous time point but has not been updated to the current time point;
performing association between (i) current time point cluster information among the cluster information and (ii) the current prediction of the track that has been updated up to the previous time point, to generate an association result; and
performing tracking of multiple objects based on the association result.

12. The method of claim 11, wherein
the at least one autonomous driving sensor includes a plurality of radar sensors.

13. The method of claim 12, wherein
the performing of the preprocessing includes converting a sensor coordinate system of each of the plurality of radar sensors into a coordinate system of a vehicle equipped with the plurality of radars.

14. The method of claim 13, wherein
the performing of the preprocessing includes performing noise filtering using signal information provided by the plurality of radar sensors and data information around the detection points.

15. The method of claim 12, wherein
the clustering includes clustering the detection points into the plurality of clusters based on position information and velocity information obtained from the plurality of radar sensors.

16. The method of claim 15, wherein
the clustering includes performing clustering based on a result of time-series accumulation of the multiple point data from the plurality of radar sensors, based on a determination that there is a detection point at a distance greater than a threshold distance from the plurality of radar sensors.

17. The method of claim 12, wherein
the cluster information includes at least one of a longitudinal velocity, a lateral velocity, a heading direction, a position, or cluster box information.

18. The method of claim 17, wherein
the generating of the cluster information includes:
determining Doppler information for a detection point in a cluster among the plurality of clusters;
generating a representative velocity vector based on the Doppler information for the detection point included in the cluster; and
generating box information and a representative position of the cluster based on position information of the detection point included in the cluster.

19. The method of claim 12, wherein
the performing of the association includes:
obtaining the track that has been updated up to the previous time point and a cluster newly observed at the current time point,
predicting a current time point position of the track using position and velocity information at the previous time point to generate the current prediction of the track that has been updated up to the previous time point, and
performing an association between (i) the current prediction of the track that has been updated up to the previous time point and (ii) multiple clusters among the plurality of clusters.

20. The method of claim 11, wherein
the performing of the tracking of the multiple objects includes adjusting an update rate of past data and current observation data.
